(19) United States
(12) Patent Application Publication
(10) Pub. No.: US 2004/0016619 A1
(43) Pub. Date: Jan. 29, 2004

(54) Synchronizer

(75) Inventors: Daniel A. Monette, Battle Creek, MI (US); Mark A. Hirsch, Vicksburg, MI (US); Bohdan Lisowsky, Troy, MI (US); Mark W. Marklin, Kalamazoo, MI (US); Douglas B. Barton, Marshall, MI (US); Patrick L. Brown, Battle Creek, MI (US)

Correspondence Address: Kevin M. Hinman, 26201 Northwestern Hwy., P.O. Box 766, Southfield, MI, 48037, US

(73) Assignee: Eaton Corporation, Cleveland, OH

(21) Appl. No.: 10/426,309

(22) Filed: Apr. 30, 2003

Related U.S. Application Data
(60) Provisional application No. 60/376,524, filed on Apr. 30, 2002.

(51) Int. Cl. B23P 17/00; F16D 13/00

(52) U.S. Cl. 192/107 M; 29/417; 192/53.34

(57) ABSTRACT

A method for forming a transmission synchronizer friction surface includes the steps of forming a woven substrate fabric, oxidizing the substrate fabric, carbonizing the substrate fabric, densifying the carbonized substrate fabric, burnishing the densified carbonized substrate fabric, applying a thermoset adhesive to the burnished substrate fabric, and heating and pressing the piece of fabric against a conical surface of a synchronizer element. To form the fabric, yarn is formed of chopped substrate fibers, and the yarn is woven to form the woven substrate fabric. Densification is increased by extending a period of time of chemical vapor deposition to achieve a weight in an unburnished condition of at least 16 ounces per square yard for a thickness range of approximately 40 to 50 mils. Both sides of the substrate fabric are burnished. The material is pressed against the conical surface under a high pressure of at least 2000 psi to achieve the desired bonding of the substrate fabric to the conical surface.

### RELATED APPLICATIONS

This application is a Continuation-In-Part of U.S. Provisional Application Serial No. 60/376,524, and claims the benefit of U.S. Provisional Application No. 60/376,524, filed Apr. 30, 2002.

### BACKGROUND OF THE INVENTION

1. Field of the Invention

The present invention relates generally to carbon based friction materials, methods of making such friction materials and methods of bonding such friction materials to a metal supporting material. More particularly, the present invention relates to friction materials formed of pyrolytic-carbon fabric material, methods for making same and methods for bonding such material to metal conical elements for use as a transmission synchronizer clutching element.

2. Description of the Related Art

In gear change mechanism synchronizers or gear change clutch elements, there are two cooperating members having a frictional interface. Generally, at least one of the cooperating members is a support member and has a friction material surface adapted to be moved into and out of frictional engagement with an opposing surface on the other cooperating member. In transmissions, both of the cooperating members typically move in a liquid, generally some type of cooling and lubricating oil between the cooperating members. One friction material which has the desirable characteristics for such an application is a pyrolytic-carbon fabric material.

One such pyrolytic-carbon fabric material is disclosed in U.S. Pat. No. 4,291,794, which describes one way of forming the pyrolytic-carbon fabric material by densifying a single layer of woven cloth formed of carbon yarn strands.

The pyrolytic-carbon fabric material is formed in several stages.

First, an appropriate precursor material is chosen of which the carbon fibers are to be formed. Known precursor materials include wool, rayon, polyacrylonitrile and pitch.

The fibers are then oxidized by elevating them in temperature in an oxygen inclusive atmosphere. Oxidizing the fibers stabilizes them.

The oxidized fibers are then formed into a substrate cloth. The resultant fiber fabric may be formed into a nonwoven fabric or a woven fabric, such as continuous-filament fabric, spun yarn fabric, or a combination thereof. Nonwoven fabric generally refers to coherent fibrous material formed without uniform interlacing of yarn strands, such as batting or felt. Felt is a fabric formed of fibers through the action of heat and pressure. In continuous-filament yarn fabric, the yarn strands are continuous and interlacing. Spun yarn fabric includes some fibers of short length which are spun into fuzzy, fluffy yarns. Short length fibers may be formed by cutting longer fibers. Woven fabric substrates used in the present invention are in the form of a single layer of fabric.

The carbon-fiber fabric substrate cloth is transformed into carbon fiber cloth, or carbonized, by heat treating it at temperatures on the order of about 1000° C. or more in an absence of air. The absence of air can be accomplished by heating the cloth in a vacuum or in a non-oxidizing atmosphere such as an inert or other non-reactive gas. Alternatively, the fibers may be carbonized before weaving them into cloth.

Densification of the carbonized substrate is achieved by using chemical vapor deposition to deposit pyrolytic carbon onto the woven cloth. The densified cloth is then bonded onto the operating surface of one or more of the cooperating members. The surface of the densified woven cloth may then be ground or sanded to roughen the surface to facilitate bonding the cloth to a metal surface.

A thermoset adhesive is applied to the carbon fiber cloth. The cloth is bonded to a metal structural support, such as a transmission synchronizer cone, under an application of heat and pressure.

The prior art has some significant shortcomings.

The bond between the carbonized cloth and the synchronizer would weaken earlier than desired when subjected to high loading. It was theorized that heat transferred through the cloth to the bonding interface was causing the bond to deteriorate.

Therefore, the present invention seeks to increase the durability of the carbonized cloth and the bond bet between the cloth and the underlying structure, when it is subjected to high loading.

### SUMMARY OF THE INVENTION

The present invention provides an improved synchronizer and an improved method of fabricating a synchronizer frictional engagement surface which improves the durability of the carbonized cloth, including the durability of the bonding of the carbonized cloth to the metal support structure, when subjected to high loading.

Other advantages of the present invention will be readily appreciated as the same becomes better understood after reading the subsequent description taken in conjunction with the appendant drawings.

### BRIEF DESCRIPTION OF THE DRAWINGS

FIG. 1 is a sectional view of an auxiliary transmission section of a compound transmission.

FIG. 2 is a schematic sectional view of a range synchronizer assembly for an auxiliary transmission section like that of FIG. 1.

### DESCRIPTION OF THE PREFERRED EMBODIMENT(S)

It is understood that although the present invention is illustrated as disposed within an auxiliary transmission section commonly disposed at the back or rear end of a transmission suited for use in a heavy duty commercial vehicle, and while the present invention is particularly well suited for such a transmission structure, the advantages of the present invention are equally applicable to transmissions of other types.

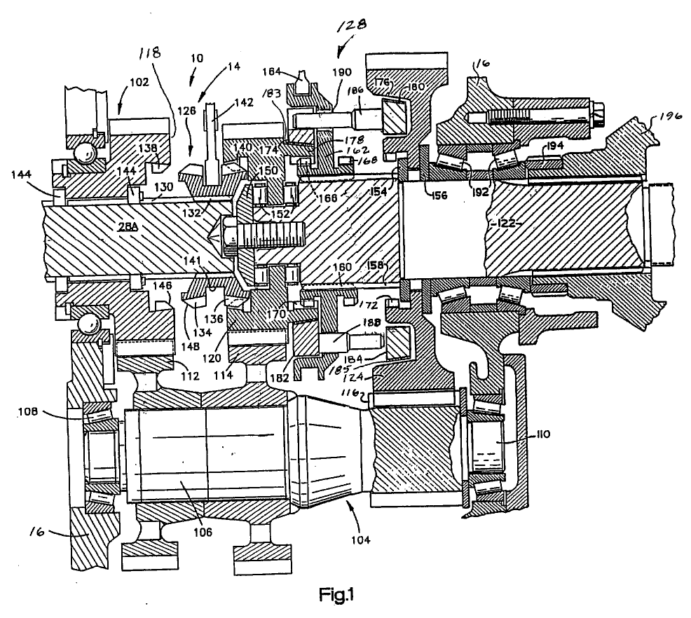

An auxiliary transmission section 14 of a compound transmission 10, not shown in its entirety, includes two substantially identical auxiliary countershaft assemblies only one of which 104 is shown in FIG. 1. Each assembly 104 comprises an auxiliary countershaft 106 supported by bearings 108 and 110 in housing 16 and carrying three auxiliary section countershaft gears 112, 114 and 116 fixed for rotation therewith. Auxiliary countershaft gears 112 are constantly meshed with and support auxiliary section splitter gear 118 which surrounds mainshaft 28A. Auxiliary countershaft gears 114 are constantly meshed with and support auxiliary section splitter/range gear 120 which surrounds an output shaft 122 at the end thereof adjacent the coaxial end of mainshaft 28A. Auxiliary section countershaft gears 116 constantly mesh and support auxiliary section range gear 124, which surrounds the output shaft 122. Accordingly, auxiliary section countershaft gears 112 and splitter gear 118 define a first gear layer, auxiliary section countershaft gears 114 and splitter/range gear 120 define a second gear layer and auxiliary section countershaft gears 116 and range gear 124 define a third layer, or gear group of the combined splitter-and-range-type auxiliary transmission section 102.

A sliding two-position jaw clutch collar 126, alternatively characterized as a splitter clutch, is utilized to selectively couple either the splitter gear 118 or the splitter/range gear 120 to the mainshaft 28A. A two-position synchronized clutch assembly 128, alternatively characterized as a range clutch, is utilized to selectively couple the splitter/range gear 120 or the range gear 124 to the output shaft 122. Synchronized clutch assemblies such as assembly 128 are well known in the prior art and examples thereof may be seen by reference to U.S. Pat. Nos. 5,679,096, 4,462,489; 4,125,179 and 2,667,955, the disclosures of which are incorporated herein by reference.

The detailed structure of the preferred embodiment of auxiliary section 14 is illustrated in FIG. 1, wherein it may be seen that the rearward end of mainshaft 28A extending from the main transmission section (not shown) into the auxiliary transmission section 102 is provided with external splines 130, which mate with internal splines 132 provided on clutch collar 126 for rotationally coupling clutch collar 126 to the mainshaft 28A, while allowing relative axial movement therebetween. The clutch collar 126 is provided with clutch teeth 134 and 136 for selective axial engagement with clutch teeth 138 and 140 provided on gears 118 and 120, respectively. The clutch collar 126 is also provided with a groove 141 for receipt of a shift fork 142.

Gear 118 surrounds mainshaft 28A and is normally free to rotate relative thereto and is axially retained relative to the mainshaft 28A by means of retainers 144. Clutch teeth 136 and 138 present tapered surfaces 146 and 148, which are inclined at about 35° relative to the axis of the mainshaft 28A, which provides an advantageous interaction tending to resist non-synchronous engagement and also tending to cause a synchronous rotation, as is described in greater detail in U.S. Pat. No. 3,265,173, the disclosure of which is incorporated herein by reference. Clutch teeth 136 and 140 are provided with similar complementary tapered surfaces.

Splitter/range gear 120 is rotatably supported at the inward end 150 of output shaft 122 by means of a pair of thrust bearings 152 while range gear 124 surrounds the output shaft 122 and is axially retained thereon by means of thrust washers 154 and 156. Located axially between gears 120 and 124, and rotationally fixed to output shaft 122 by means of external splines 158 and internal splines 160, is the double acting two-position synchronized clutch assembly 128. Many of the well known synchronized positive clutch structures are suitable for use in the auxiliary transmission section of the present invention. The synchronized clutch assembly 128 illustrated is of the pin type described in U.S. Pat. No. 4,462,489, the disclosure of which is incorporated herein by reference. Briefly, the synchronized clutch assembly 128 includes a slidable jaw clutch member 162 axially positioned by a shift fork 164 and carrying clutch teeth 166 and 168, respectively, for axial engagement with clutch teeth 170 and 172, respectively, carried by gears 120 and 124, respectively. Gears 120 and 124 define cone friction surfaces 174 and 176, respectively, for frictional synchronizing engagement with matching frictional cone surfaces 178 and 180, respectively, carried by the friction rings 182 and 184, respectively, of the synchronized clutch assembly. Friction rings 182 and 184 have bonded thereto friction material layers 183 and 185 respectively. Friction material layers 183 and 185 are formed of pyrolytic carbon material which is described in more detail below. Blocker pins 186 and 188 are rotationally fixed to the friction rings 184 and 182, respectively, and interact with blocker openings 190 carried by the slidable jaw clutch member 162 to provide the blocking function, as is well known in the prior art. Synchronized assembly 128 may also include a plurality of spring pins (not shown) for providing initial engagement of the conical friction surfaces at the initiation of a clutch engagement operation.

Output shaft 122 is supported by bearings 192 in housing 16 and extends therefrom for attachment of a yolk member 196 or the like, which typically forms a portion of a universal joint for driving a propeller shaft to a differential of a drive axle or the like. The output shaft 122 may also carry a speedometer gear 194 and/or various sealing elements (not shown).

By selectively axially positioning both the splitter clutch 126 and the range clutch 128 in the forward and rearward axial positions thereof, four distinct ratios of main shaft rotation to output shaft rotation may be provided. Accordingly, auxiliary transmission section 102 is a 3-layer auxiliary section of the combined range-and-splitter type providing four selectable speeds or drive ratios between the input (countershaft 28A) and output (output shaft 122) thereof. In compound transmission 10, the main section provides a reverse and five potentially selectable forward speeds. However, one of these selectable forward main section gear ratios is often a creeper or low gear not intended to be used in the high range. Thus, transmission 10 is properly designated as a (4+1)×(2)×(2) type transmission providing 17 or 18 selectable forward speeds depending upon the desirability and/or practicality of splitting the low or creeper gear.

While clutch 128, the range clutch, should be a synchronized clutch, double-acting clutch collar 126, the splitter clutch, is not required to be synchronized. Of course, one or both of the clutches defined by collar 126 could be of the synchronized type.

One pyrolytic-carbon fabric material suited for use as layers 183 and 185 is disclosed in U.S. Pat. No. 4,291,794, which describes one way of forming the pyrolytic-carbon fabric material by densifying a single layer of woven cloth formed of carbon yarn strands and is hereby incorporated by reference. Also incorporated herein by reference are the teachings of U.S. Pat. Nos. 4,700,823; 4,778,548; 4,844,218; 5,033,596; 5,091,041; 5,221,401 and 5,858,511. The present invention is an improvement of such materials and a method of making such improved materials.

In a preferred embodiment of the present invention, polyacrylonitrile is chosen as the precursor material of which fibers are formed. The fibers are preferably formed into spun yarn, employing short length fibers of, in one embodiment, one to three inches in length.

The polyacrylonitrile fibers are oxidized by elevating them in temperature in an oxygen inclusive atmosphere. Oxidizing the fibers stabilizes them. The fibers may be in fiber form, or in yarn form when oxidized.

The oxidized fibers, if still in fiber form, are spun into yarn.

Spun yarn advantageously results in a puffier, fuller and less directional material than that produced from continuous filament yarn. The resultantly less directional material conducts less heat over a defined period of time from the engagement surface where heat energy is generated to the bonding surface than relatively directional material. The reduction in heat transfer helps prevent the adhesive at the bonding surface from suffering heat induced deterioration.

The spun yarn is then woven into a substrate cloth or fabric. The cloth is preferably of a 2×2 basket square weave construction, and also is preferably open or porous. Woven fabric substrates used in the present invention are in the form of a single layer of fabric.

The woven fabric is next transformed into carbon fiber material, or carbonized, by heat treating it at temperatures on the order of about 1000° C. or more in an absence of air. The process is referred to herein interchangeably as carbonizing and carbonization. The absence of air can be accomplished by heating the cloth in a vacuum or in a non-oxidizing atmosphere such as an inert or other non-reactive gas. In a preferred embodiment, the post-carbonization warp count is 22.5±1.5 pair/inch, and the fill count is 21.5±1.5 pair/inch. The thickness is preferably 37±2.5 mils. The weight of the resultant carbonized material is approximately 10.2±0.8 oz/square yard. It should be appreciated that the fabric will shrink appreciably as a result of the carbonizing process.

Alternatively, the cloth may be woven from carbonized yarn, after the step of carbonizing the fibers.

Densification of the carbonized substrate is achieved by using chemical vapor deposition to deposit pyrolytic carbon onto the woven cloth. The densified cloth is then bonded onto the operating surface of one or more of the cooperating members. The surface of the densified woven cloth may then be ground or sanded to roughen the surface to facilitate bonding the cloth to a metal surface. The cloth preferably remains porous after densification.

The thickness after densification is 40-50 mils. The areal weight increases to 20±4 oz/square yard.

The material is ground or burnished flat on both sides to remove loose elements such as fuzz balls which increase the thickness of the material without adding significantly to the wear capacity of the material. The removal of such elements also makes the material more resistant to compression. In a preferred embodiment, 0.007 inches of material is removed on the adhesive side and 0.002 inches is removed on the engagement side. The finished thickness is approximately 0.025 inches.

A thermoset adhesive is applied to sheets of the carbon fiber cloth.

The densified cloth is cut to the necessary side and shape to form friction material layers 183 and 185. It should be appreciated that cutting could potentially occur at other earlier stages in the fabrication of the friction material. However, particularly when the material is woven before it is carbonized, cutting after carbonizing is beneficial in that, as noted above, the material or fabric shrinks significantly as a result of the carbonization process. Layers 183 and 185 are placed over cone surfaces 178 and 180 and subjected to a combination of heat and pressure to cause the thermoset adhesive to fix layers 183 and 185 to surfaces 178 and 180. It should be appreciated that layers 183 and 185 may be cut to a size and a shape such that they would each be defined by a single piece, or, alternatively, by a plurality of pieces. The bonding pressure is at least 2000 psi and is preferably approximately 4000 psi (pounds per square inch).

The above described improved method of forming and bonding the friction material results in a reduced rate of wear, and particularly reduces the initial rate of wear, of layers 183 and 185. In light of this, and in light of the increased thickness of the layers 183 and 185, corresponding dimensional changes can and should be made to the associated synchronizer assembly 128.

Specifically, the length A of a gage portion or large diameter portion of pin 188, which may be characterized as the high range pin 188, is preferably shortened to accommodate the thicker friction material layer 183. In one preferred embodiment, length A is shortened by 0.050 inches. Accordingly, the clutching teeth 170 on gear 120 are also shortened by 0.050 inches to avoid premature and unsynchronized engagement with teeth 166. The overall length B of pin 188 is shortened as well to avoid any undesired butting of pin 188 against friction ring 184. Shortening length A also beneficially contributes to the anticipated life of the synchronizer clutch assembly 128, as it increased an available gap C which permits wear related travel of ring 118 toward gear 120. When gap C is reduced to zero due to wear of friction material layer 183, ring 118 is no longer able to generate a clutching load against gear cone surface 174.

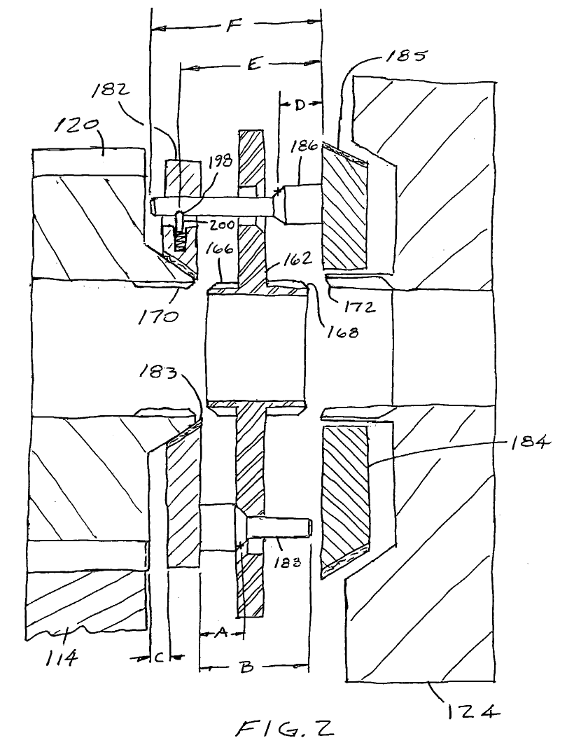

Similarly, the length D of a gage portion or large diameter portion of pin 186, which may be characterized as the low range pin 186, is also preferably shortened by the same amount, as are teeth 172 on gear 124. If a detent or notch 198 and spring biased check element 200 such as a steel ball are employed as shown in FIG. 2, it may be desirable to decrease the distance E between detent notch 198 and ring 184. It may also be desirable to decrease the overall length F of pin 186.

The industrial applicability of the present invention includes any use of the improved friction material in wet friction engaging mechanisms. The friction material provided may be adhered to a support member to form a wet friction member which is part of a wet friction engaging mechanism. Such wet friction members include cones, such as transmission synchronizer cones, and plates, such as retarder plates, differential plates, clutch plates, transmission plates, and brake plates. The wet friction members are also part of the present invention.

We claim:

1. A method for forming a transmission synchronizer friction surface comprising:
forming a woven substrate fabric formed of an appropriate precursor fiber suitable for forming carbon fiber;
oxidizing the substrate fabric by subjecting the substrate to a first elevated temperature in an atmosphere including oxygen;
carbonizing the substrate fabric by subjecting the substrate to a second elevated temperature in a non-oxidizing atmosphere;
after carbonizing, densifying the substrate fabric by chemical vapor deposition so as to deposit pyrolytic carbon on the substrate fabric;
after densifying, burnishing the substrate fabric;
after burnishing, applying a thermoset adhesive to a bonding side of the substrate fabric;
cutting a piece of the substrate fabric of a size suited for use on a synchronizer element;
after applying the adhesive and cutting the piece of the substrate fabric, heating and pressing the piece of fabric against a conical surface of the synchronizer element with the bonding side disposed against the conical surface, said method characterized by:
spinning a yearn of chopped substrate fibers;
weaving the yarn into the woven substrate fabric;
increasing densification by extending a period of time of chemical vapor deposition to achieve a weight in an unburnished condition of at least 16 ounces per square yard for a thickness range of approximately 40 to 50 mils (0.040 to 0.050 inches);
burnishing both sides of the substrate fabric to remove a predetermined amount of material from each side; and
pressing the substrate fabric against the conical surface under a high pressure of at least 2000 psi to achieve the desired bonding of the substrate fabric to the conical surface.

2. The method of claim 1 wherein the burnishing removes approximately 7 mils (0.007 inches) of material on a side of the substrate fabric to which the thermoset adhesive is to be applied, and the burnishing removes approximately 2 mils (0.002 inches) of material on an engagement side of the substrate fabric opposite the side to which the adhesive is applied.

3. The method of claim 1, wherein the high pressure is approximately 4000 psi.

4. The method of claim 2, wherein the high pressure is approximately 4000 psi.
